(19) United States
(12) Patent Application Publication
(10) Pub. No.: US 2012/0316658 A1
(43) Pub. Date: Dec. 13, 2012

(54) WEB BASED REMOTE MONITORING AND CONTROL SYSTEM

(75) Inventor: Daniel John Glew, Auckland (NZ)

(73) Assignee: EXELOO LIMITED, Auckland (NZ)

(21) Appl. No.: 13/578,635

(22) PCT Filed: Feb. 14, 2011
(86) PCT No.: PCT/NZ2011/000021

§ 371 Date: Aug. 13, 2012

(30) Foreign Application Priority Data
Feb. 15, 2010 (NZ) 583295

(51) Int. Cl. G05B 15/00

(52) U.S. Cl. 700/1

(57) ABSTRACT

An Internet-based remote monitoring and control system for monitoring and controlling automated facilities comprising of one or more automation means and one or more communication means located at the facilities, a service means, wherein the service means interfaces with a protocol adaptation means, interaction means having at least one interface presentation means and one or more input/output means. The system establishes an Internet-based first connection between an automation means and the service means where the connection is facilitated by a communication means that acts as a transparent proxy. The system transfers ‘automation means monitoring and controlling data’ to and from the protocol adaptation means through the first connection which further enables a second connection between itself and an interaction means, and translates and transfers ‘automation means monitoring and controlling data’ to and from the interaction means which is monitored and controlled by a user.

The invention relates to a remote monitoring and control system. More particularly it relates to an Internet-based remote monitoring and control system for an automated facility.

### BACKGROUND OF INVENTION

In industry programmable logic controllers (PLCs) are commonly used to automate electromechanical processes at various different facilities. There have been several previous attempts for remote monitoring and controlling the operation of PLCs through the web. All prior art methods have many inherent disadvantages as described in this section.

In order to remotely monitor and control one or more PLCs, a connection must be established between the PLCs and a remote PC. The PLCs are connected to an intelligent modem for this purpose so that the modem could establish a remote connection with a PC at a monitoring station to enable the exchange of data between the PLCs and the PC. The remote connection is typically a dial up or an on-request TCP/IP connection.

According to the prior art method shown in FIG. 1, the firmware of the intelligent modem directly communicates with the PLCs and data is retrieved and stored on the modem itself. The data stored on the modem is limited by the storage capacity of the modem. When required, a connection is established to a remote PC and the data stored on the modem is sent to the PC. It could be seen that only data specifically made available by the firmware application can be retrieved using this method. Adding to the data available would require the firmware on the modem to be updated. Firmware must be updated on all connected intelligent modems individually when monitoring multiple groups of PLCs at various different facilities. The software used on the PCs may also need to be updated and redistributed.

Another prior art method of remote monitoring and control is shown in FIG. 2. The intelligent modem of this model includes a web server feature that allows data from the PLCs to be viewed as web pages. Therefore the remote PC could access the data of the PLCs via a web browser instead of using specialized software. However all other disadvantages of the previous model still exist in this model. In particular the web server features of the modem are extremely limited and reprogramming/debugging is difficult. Also the firmware would still require redistribution to all sites when firmware of the modem is updated.

According to the prior art method of FIG. 3, a local PC is used at the facility location of the PLCs instead of using an intelligent modem by itself. With this method, more information is made available to the remote monitoring PC through the local PC attached to the PLCs. However specific software must be installed on the local PC to extract and store data from the PLCs and additional software is needed for exposing information relating to the facility of the PLCs to allow remote access via various protocols. Therefore only data which is stored on the local PC can be retrieved and adding to this data would require updating of the software for accessing the PLCs and the software for exposing this information. Furthermore software on all local PCs must be updated when monitoring multiple groups of PLCs at different facilities. The local PC also requires regular maintenance and more space to operate than an intelligent modern.

In the prior art method of FIG. 4, a dedicated server computer is used so that data obtained from the PLCs is stored on a server that can be accessed by any remote PC when required. As in the previous models the modem contains specialized firmware for extracting data from the PLCs and only the data made available by the firmware can be retrieved through the server. The modem also includes features for reporting data to the server computer. Adding to the data would require firmware updating of the modem and when using multiple groups of PLCs, firmware on all connected modems must be updated. The server computer consists of a server application for communicating with the firmware of the modem, a database for storing retrieved data from the modem and host software for exposing data for remote access via various protocols to the remote PC. The remote PC also includes specialized software accessing data from the server. All of these components would need to be updated individually when an update is required which can be time consuming and expensive. The server has a database intermediary where PLC data is stored and updated frequently and hence the data cannot be viewed in real-time by the end-user.

A further problem of the traditional models was noted when providing constant TCP/IP connections between the remote PC/server and the intelligent modem at the facilities. The connection between the modem and the remote PC can only be established when the modem opens an Internet socket out to the remote PC or to the server. Opening an Internet socket from the remote PC is usually not possible since the modem has a dynamic IP address and the remote PC cannot find the new IP address of the modem and the modem has to re-establish its Internet connection. In order to allow the server/remote PC to find the IP address of the modem when disconnected, a feature may be built into the modem firmware to contact the remote PC/server and report its IP address for storage in a database. However most ISPs block incoming socket requests meaning that opening an Internet socket to a modem from a remote PC/server is not possible. Hence the server is unable to establish an Internet connection with the modem on-demand. Some ISPs allow incoming socket requests, but this may expose the system to high data-costs from unsolicited Internet traffic requests. A variety of methods have been tried in the prior art to overcome these problems as listed below:
The use of dial-up communication with the modem.
Instruct the modem firmware to regularly establish connections with the remote PC/Server, update its database infatuation and disconnect.
The use of a different communication mechanism to tell the modem to establish a connection to the server when it is required, such as sending the modem an SMS message or having it establish a connection when certain events arise at the facility.

None of these solutions provide real-time, on-demand access to the intelligent modem from a website based on a server.

The traditional models use various methods for providing communication between a server and PLCs. The prior art methods are shown below along with their disadvantages:
Using an interpreter program stored on-board the intelligent modems, with features for retrieving specific information from the PLCs. This involves the licensing of expensive code libraries with no direct connectivity to the web, and working with the restrictive, slow development environment of the firmware operating system within the modem.
Having direct dial access to the modem, allowing direct access to specific areas of the PLCs. This involves the use of communication protocols proprietary to the PLC manufacturers, for which no documentation is publicly available. It is limited to particular regions of the PLC registers only and furthermore requires using a dial-up connection which eliminates the advantages of Internet-based access and involves the use of expensive toll calls.

Therefore the prior art does not allow for a real-time Internet-based means of communication between the PLCs and a server. Although flow control features already exists on some modems which can be developed into a successful form of communication, the only applications of these features in the prior art involves information flowing in from either a serial port or an Internet port of the modem, and data from these sources being interpreted and processed by the modem firmware which limits its capabilities. Documentation and support for modifying these applications is also severely limited.

Providing Internet-based access directly to the retrieved PLC data also provides some problems. In the prior art no code libraries were available to interpret PLC data in a way that could interface with Internet sockets and web technologies. The required interpretive code libraries with such functionality have not been previously developed and the development process has been deemed too difficult by the manufacturers.

A further problem of the traditional models is that some government and private institutions not allowing software to be installed on computers owned by them old hence the installation of specialized software on the remote PCs may not be possible when installing the system to monitor and control a specific government or private facility with PLCs.

Several other limited monitoring methods exists in the prior art including the use, of an Intellicom OP6600 development kit. The kit includes an alphanumeric screen that is installed at each facility and downloads information from the PLCs at the facility and transmits it by a telephone landline. The system is very difficult to operate and if it fails the user must go to the facility location to try to rectify the situation.

Another method is the use of an IFIX Scada Package. The package requires a dongle to be connected to the back of a remote PC which provides access to the Scada system that is capable of providing wireless remote monitoring of facilities. However this system is very limited in its capabilities and is extremely difficult to operate suceessfully.

A further method is to use a Fuji SPB series PLC with a touch screen POD module for monitoring facilities. The module allows monitoring of the facilities through a modem with a dial-up connection using a landline. However the specialised software used for monitoring is expensive to develop and must be installed in PCs of all distributors and customers to enable them to communicate with the individual facilities. This is very cumbersome and difficult when there is a failure to the system as it requires a visit to the facility location and also to the customer's PC containing the software. The monitoring service provider is required to provide after-sales service and backup when the software fails but there is no mechanism to charge the customers for access and the service provided by the service provider because the customers already have a copy of the software on their PCs and are able to access the software at will with no payment for the service. The software cannot be installed on some customer PCs where the security of their computer network does not allow specialist software to be installed onto their system.

A similar system to the above can he developed using a Wavecom modem with a special CSD data SIM card that allows the use of a wireless cellular phone line instead of a land line. This system is more user-friendly and provides more information than a landline based system but still incorporates the downfalls of the original system as described above.

Another method of providing remote monitoring of PLCs is to use SPH class PLCs with web-connection modules. Unfortunately these modules are available only for SPH class PLCs which have different configurations and functions to other PLCs and hence integrated operation with other PLC systems is difficult. Furthermore they require their own cellular account to operate and integrated operation with an intelligent modem that has additional features would require two cellular accounts per facility. These modules can be programmed to send limited PLC data intermittently by FTP or email to a remote PC. However PLC data is only available intermittently and cannot be accessed on-demand. The scope and quantity of PLC data which can be transmitted is also extremely limited. Moreover it only allows for the monitoring of the PLCs and PLC control is not possible. The modules can also host websites on-board where limited current PLC data can be viewed. The built-in website hosted by the module is extremely basic and cannot show data from multiple facilities. Furthermore it cannot show any data Meaningful to end-users, as only raw data is shown directly from PLC registers and also access to the website cannot be controlled, hence it cannot he used for revenue generation. These PLCs can host custom websites but each module has extremely limited storage capacity which is far less than that is required for a full-featured, interactive website, and furthermore improving the website would mean updating all the facilities individually each time.

Therefore it could be understood that the prior art does not provide an Internet-based remote monitoring and control system for one or more automated facilities that is able to request any information from any number of PLCs located at the facilities at any given time. The prior art also does not allow centralised development of a remote monitoring system for Internet-connected facilities.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT OF THE INVENTION

It is an object of the invention to provide a remote monitoring and control system that ameliorates some of the disadvantages and limitations of the known art or at least provide the public with a useful choice.

### SUMMARY OF INVENTION

In a first aspect the invention resides in an Internet-based remote monitoring and control system comprising:
one or more automation means located at one or more facilities,
one or more communication means located at one or more facilities,
a service means, the service means interfacing with a protocol adaptation means,
one or more interaction means,
   wherein

at least one Internet-based first connection between an automation means and the service means is established and maintained,

at least one second connection between the protocol adaptation means and an interaction means is established as required,

the first connection(s) between the automation means and the service means is being facilitated through the communication means, the communication means acting as a transparent proxy for the connection(s),

the service means makes the first connection(s) available to the protocol adaptation means to enable transfer of ‘automation means monitoring and/or controlling data’ between the automation means and the protocol adaptation means,

the protocol adaptation means enables the second connection(s) from the interaction means and enables transfer of ‘automation means monitoring and/or controlling data’ between the automation means and the interaction means,

the protocol adaptation means translates data received in the communication protocol of the automation means into the communication protocol of the interaction means and/or vice-versa.

Preferably the first connection(s) between the automation means and the service means is established by the communications means.

Preferably the second connection(s) between the protocol adaptation means and an interaction means is established when required by the interaction means.

Preferably the first connection(s) between the automation means and the service means is kept alive by the service means.

Preferably the interaction means is a combination of one or more interface presentation means and one or more input/output means.

Alternatively the interaction means is an automated or semi-automated software program such as a windows application, Internet application or a smart phone application capable of automatically controlling and monitoring one or more automation means.

Preferably the interface presentation is a website hosted on a server computer having Internet access.

Preferably at least one third connection between the interface presentation means and the input/output means is established when required by a user.

Preferably the ‘automation means monitoring and/or controlling data’ is capable of being monitored and/or changed by a user by accessing the interface presentation means through the third connection(s) between the interface presentation means and the input/output means.

Preferably the monitoring and/or changing of data through the interface presentation means results in the remote control and/or monitoring of one or more automation means located at multiple facilities in real-time.

Preferably the automation means is a programmable logic controller (PLC) capable of automating electromechanical processes.

Preferably the communication means is an Internet-capable intelligent cellular modem running transparent-proxy firmware capable of establishing an Internet socket connection.

Preferably the communication means will re-establish its Internet socket connection in the event that it no longer appears to be maintained.

Preferably the communication means is ‘one-size-fits-all’, meaning; no firmware, software or hardware customisation of the communication means is needed even where the system is applied to diverse and varying remote facilities and PLCs.

Preferably the service means is server software hosted on a server computer having Internet access.

Preferably the server software maintains multiple first connections between automation means (located at a plurality of facilities) and the server software, each first connection facilitated by a communication means located at each facility.

Preferably the first connections are asynchronous first connections.

Preferably the protocol adaptation means is a simple object access protocol (SOAP) service hosted on the same server computer as the service means.

Preferably the interface between the server software and the SOAP service is a direct, software interface.

Preferably the data transferred on the first connection(s) is in PLC communication language.

Preferably the data transferred on the second connection(s) is in secure, SOAP Web Service language.

Preferably the SOAP Web requests accepted by the SOAP service are formed by website developers with common knowledge using a developer-friendly programming object.

Preferably the input/output means is a remote PC having Internet access.

Preferably Internet access on the remote PC is utilised via a web browser capable of accessing a website, which makes requests to the SOAP service.

Preferably the connection between the communication means and the service means is a TCP/IP connection.

Preferably the connection between the protocol adaptation means and the interface presentation means is a TCP/IP connection.

Preferably the connection between the interface presentation means and the input/output means is a TCP/IP connection.

Preferably access to the website is controlled by login and password details issued to users.

Preferably the intelligent modem can send out notifications to users regarding low priority or high priority alarms or other maintenance information at the facilities.

Preferably the notifications are sent in the form of alarm SMS messages o mobile phones of users.

Preferably the SMS messages contain information that identifies the type of alarm and the location of the facility.

Preferably administrative users can change the modem settings by sending SMS messages with appropriate codes to the modem.

Preferably administrative users can change the phone numbers to which the modem will send the alarm SMS messages, by sending SMS messages with appropriate codes to the modem.

Preferably the system can automatically contact all of the facilities at the desired intervals to gather automation means monitoring data and generate automatic reports.

Preferably users can contact the facilities in real-time and diagnose problems at the facilities.

Preferably the system can monitor and control any automated facility.

Preferably the system can monitor and control any automated toilet facility.

Preferably the system can monitor and control a non-automated facility after automating the facility with a kit containing a power pack, PLCs, a modem and sensors.

Preferably the remote monitoring and control system allows the simulation of one or more direct, local connection(s) to PLC(s) at remote location(s) from a central Internet server.

Preferably the remote monitoring and control system provides low-cost, real-time access to PLCs via a continuous data connection between remote PLCs and a central server computer, without requiring a static IP address for each facility location.

Preferably the remote monitoring and control system provides remote, monitoring and controlling capabilities via the Internet without the need to have any specific software running on the PLCs nor any site-specific software or firmware on devices local to the PLCs.

Preferably the remote monitoring and control system allows remote data costs to be minimized by transmitting only raw PLC data from the remote site of the PLCs with no data comprising user-interface or mid-level protocols being transmitted.

Preferably the remote monitoring and control system allows all required changes to PLC data to be implemented from a convenient, centralised location and all monitoring/control interface features are also provided from this location.

Preferably the remote monitoring and control system allows future developments and alterations to software to be done using high-level, efficient web-programming technology implemented on the remote server computer.

Preferably the website is able to provide additional support for marketing media, e-commerce, graphical reports and user-access control.

Preferably the remote monitoring and control system allows various facilities at multiple remote locations to be monitored, controlled and compared simultaneously through a single webpage.

Preferably the remote monitoring and control system allows PLCs at multiple remote locations to be monitored and controlled in real-time via a web service interface such as SOAP, without any web services being implemented at any of the remote locations.

In another aspect, the invention resides in a method of Internet-based remote monitoring and controlling an automated facility wherein the method comprises the steps of:
establishing and maintaining at least one Internet-based first connection between one or more automation means located at at-least one facility and a service means, the first connection(s) being facilitated by a communication means located at the facility and the communication means acting as a transparent proxy for the connection(s),
a protocol adaptation means interfaced with the service means being made available for a second connection from at least one interaction means,
establishing at least one second connection between the protocol adaptation means and the interaction means as required to transmit ‘automation means monitoring and/or control’ data,
the protocol adaptation means passing and/or translating requests and responses between the service means and the interaction means,
the service means transmitting the requests and responses across the appropriate applicable first connection(s) to the applicable automation means resulting in the monitoring and/or control of the applicable automation means.

Preferably the interaction means is a combination of an interface presentation means and an input/output means.

More preferably the method comprises a further step of a user establishing at least one third connection when required, between the interface presentation means and an input/output means, the user interacting with the interface presentation means through the third connection(s) with the input/output means and monitoring and changing data made available through the requests and responses.

This invention may also be said to consist in the parts, elements and features referred to or indicated in the specification of the application, individually or collectively, and any or all collectively of any two or more of the parts, elements or features, and where specific integers are mentioned herein which have known equivalents such equivalents are deemed to be incorporated herein as individually set forth.

### BRIEF DESCRIPTION OF DRAWINGS

The invention will now be described, by way of example only, by reference to the accompanying drawings:

FIG. 1 is prior art diagram showing a first method of remote monitoring and control.

FIG. 2 is a prior art diagram showing a second method of remote monitoring and control.

FIG. 3 is a prior art diagram showing a third method of remote monitoring and control.

FIG. 4 is a prior art diagram showing a fourth method of remote monitoring and control.

FIG. 5 is a flow diagram of an Internet-based remote monitoring and control system in accordance with a first preferred embodiment of the invention.

FIG. 6 is a screenshot of the overview webpage used for an Internet-based remote monitoring and control website in accordance with a first preferred embodiment of the invention.

FIG. 7 is a screenshot of the status webpage used for an Internet-based remote monitoring and control website in accordance with a first preferred embodiment of the invention.

FIG. 8 is a screenshot of the alarms webpage used for an Internet-based remote monitoring and control website in accordance with a first preferred embodiment of the invention.

FIG. 9 is a screenshot of the unit configuration webpage used for an Internet-based remote monitoring and control website.

FIG. 10 is a screenshot of the time-clock webpage used for an Internet-based remote monitoring and control website.

FIG. 11 is a screenshot of the general history webpage used for an Internet-based remote monitoring and control website.

FIG. 12 is a screenshot of the comparative usage webpage used for an Internet-based remote monitoring and control website.

FIG. 13 is a screenshot of the site information webpage used for an Internet-based remote monitoring and control website.

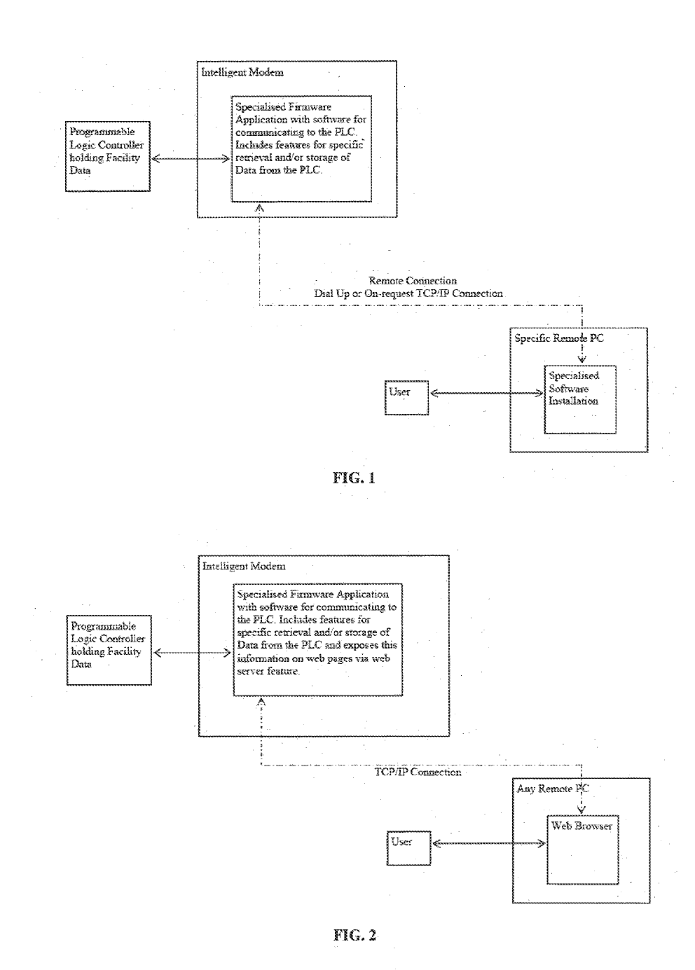

### DESCRIPTION OF THE PREFERRED EMBODIMENTS

The following description will describe the invention in relation to preferred embodiments of the invention, namely a remote monitoring and control system. The invention is in no way limited to these preferred embodiments as they are purely to exemplify the invention only and that possible variations and modifications would be readily apparent without departing from the scope of the invention.

FIG. 5 shows an Internet-based remote monitoring and control system 101. At least one automation means is located at an automated facility where the automation means is a programmable logic controller (PLC) 103. Each facility can contain more than one PLC and all PLCs in a facility are connected to a communication means such as an Internet-capable intelligent cellular modem 105. The modem allows the PLCs to connect to a service means through an Internet-based first connection. The service means is preferably in the form of server software running on a server computer 109. The server software is interfaced with a protocol adaptation means called a simple object access protocol (SOAP) service hosted on the same computer.

In the preferred embodiment, an interaction means, having an interface presentation means and an input/output means, interacts with the SOAP service through one or more second connections. The interface presentation means is preferably a website that makes connections to the SOAP service as required. Furthermore the input/output (I/O) means, where the I/O means is a remote PC 111 operated by a user 113, makes third connections to the website as required.

The Internet-based first connection between the PLCs 103 and the server software 109 is a TCP/IP connection 115. Similarly the connections between the SOAP service, the website 109 and the remote PC 111 are also a TCP/IP connections 117. Alternatively all these connections can be via various other communication protocols.

The server software 109 can receive TCP/IP first connections 115 from a plurality of additional facilities 119 which are all monitored and controlled by the system 101. Each additional facility 119 contains one or More PLCs connected to intelligent modems 105 where the modem facilitates the connection between its PLCs and the server.

Data is exchanged between. the PLCs 103 and the server software 109 through the use of the intelligent modem 105. The data relates to monitoring and controlling data of the PLCs. Data for identifying the facilities and establishing and maintaining the connections 115 is also exchanged in this method.

The firmware application on the intelligent modem is able to establish TCP/IP connections to the server software automatically. Furthermore the ‘one-size-fits-all’ firmware application acts as a transparent proxy to the PLCs in order to facilitate TCP/IP connections between the PLCs and the server software. The transparent proxy is facilitated between a serial port and an Internet socket of the modem. The intelligent modern performs flow control management between the PLCs and the server software.

In the scope of this application, a proxy is a network device connected to two other devices which are not otherwise connected together. All data transferred between the two other devices must pass through the proxy. While acting as a transparent proxy, a proxy passively transfers all data, raw and unaltered, bi-directionally between the other two devices. The application of a transparent proxy in this invention simulates a direct, local connection between a server computer and a PLC port.

The prior art problems described previously, with regards to establishing a TCP/IP connection between the server computer 109 and the intelligent modem 103 at the facilities using the PLCs, have been overcome by manipulating the fact that an open Internet socket does not cost data-traffic except while data is actually being transmitted over it. Therefore the firmware application of the modem 105 has been developed such that it establishes a permanent socket connection to the server software 109. It is thereby unnecessary for the server to attempt to find out the IP address of the modem, as whenever information is needed through a particular modem, the server software 109 can simply utilize the pre-existing permanent socket connection. The server software cart identify the facility that each modem belongs to. The server software and the firmware application of the modem have been further developed such that the permanent socket connection of each modem is kept alive when unused and also re-established if disconnected.

The server computer 109 containing the server software may also host a website. The server software is capable of maintaining multiple asynchronous connections to a plurality of PLCs at multiple facilities 119 as mentioned before. The connections to the PLCs are accessed via the TCP/IP connections 115. The server software hosts and interfaces with the SOAP service which allows simple programmatical access to arbitrary PLC data of the PLCs. However alternative protocol adaptation means such as WS-ReliableMessaging, XML-RPC, JSON-RPC, SOAPjr or Etch can be used instead of using SOAP. The SOAP service consists of the necessary translation features in order to accommodate this ability. The data obtained from the PLCs is accessed via the website utilising the SOAP service.

When the server software 109 receives a connection request from an intelligent modem 105; it utilises the translation features of the SOAP service to form a request for the identification data in a specific PLC register on the PLC connected to that modem. This request is sent to the intelligent modem 105. Then the film ware application of the modern 105 transports that request to the relevant PLC and transports the response back to the server software 109. The modem firmware application continues to do this action transporting data back and forth for all further communications. When the server software receives the response with data from the PLC register, which also contains the PLC identification number, through the connection facilitated by the modem, the server identifies the facility that the PLC belongs to and lists that facility as available for future communication by the SOAP service. A ‘keep alive’ mechanism is used to maintain the Connection between the server computer 109 and the modem 105. Requests and responses to the SOAP service can then be transmitted and received via the simple programmable interface of the website which can be accessed by any user 113 through a web browser of any remote PC 111. Therefore the system is able to provide PLC data in real-time to multiple users. All data traffic in the system is handled in parallel via asynchronous requests to avoid data traffic queues.

The SOAP service is capable of providing and receiving PLC data in PLC language/communication protocol and interpreting/translating this data so that requests and responses could be transferred via its web-accessible, simple programmable interface. The ability of the SOAP service to provide, receive and interpret/translate PLC data in PLC language is a unique feature and it allows for the direct interaction with the PLCs by the Internet-based system. The disadvantageous prior art methods mentioned earlier of having an interpreter on-board the modem and storing data on the modem itself or having direct dial access to the modem via a dial-up connection are not required due of this ability of the SOAP service.

During development, it has been realised that the development of free and complete access to PLC data was much easier when PLCs are plugged directly into a serial port of a server computer. Therefore in order to simulate this situation in the monitoring and control system, the intelligent modem 105 is setup such that it passes data between its serial port and an Internet socket. All interpretive, addressing and mapping tasks are performed on the server computer itself, and communication data Of the PLCs would simply be directed to an Internet socket instead of a serial or USB port. This is economically significant as customisation for differing facilities can all he made centrally at a server, making all on-site equipment standardised.

The existing features of flow control of the modem 105 have been utilised in this system. In order to enable the required flow control, the serial port flow control and Internet flow control features of the intelligent modem are combined. Furthermore the server software is developed such that it receives the resultant Internet socket connections and utilises them as if they were the serial port connections of the PLCs. Therefore free and complete access to PLC data is possible with these simulated serial port connections.

The PLC data retrieved from the communication method described above is interpreted/translated so that the data interfaces with web technologies and websites via the SOAP service. The interpretive code developed in order to enable this data to interface with the website also allows live access to the PLC data available to the server through its Internet sockets, without a database intermediary. This means a user is able to request an actual reading or a modification of PLC data in a monitored facility remotely and the user will not be limited by having access only to an intermittently-updated data cache.

The code is developed such that PLC data is accessible to any website development environment. This means that the website design and features could be developed conveniently, without having to build-in webpage serving features into the server software itself with slow and difficult Common Gateway Interface (CGI) style webpage development.

In order to enable these functionalities, a web-service (SOAP) based interpreter class is developed into the server computer. This interpreter class is capable of interfacing with the server code and presents itself as a standardized web-accessible information service. It is developed so that it understands a user-friendly data structure which any web developer could use in future, with enough options to read or write to any section of a PLC. This data structure includes an identification number of a remote facility containing PLCs, and after interpreting this data structure into PLC language/communication protocol, the web-service (SOAP) asks the server software to pass it onto the Internet socket for the applicable facility. When the web-service receives the response it passes the data structure populated with the desired results to the website.

In this embodiment of the invention, the interpretive engine of the SOAP based interpreter class has been developed from ground up, suited entirely for the functioning of this system. All of the features of the interpretive engine have been made web-accessible via a standardised web-service (SOAP) interface, without compromising on flexibility nor requiring any interpretation to be done by the user. Furthermore the web-service (SOAP) hosting and interfacing features of the server software has been built in the form of an ‘operating system service’ (OSS) server program. Also the secure, reliable, multi-tiered, simultaneous and asynchronous handling of distributed socket connections via multiple protocols by the server computer was required to enable the function of the system.

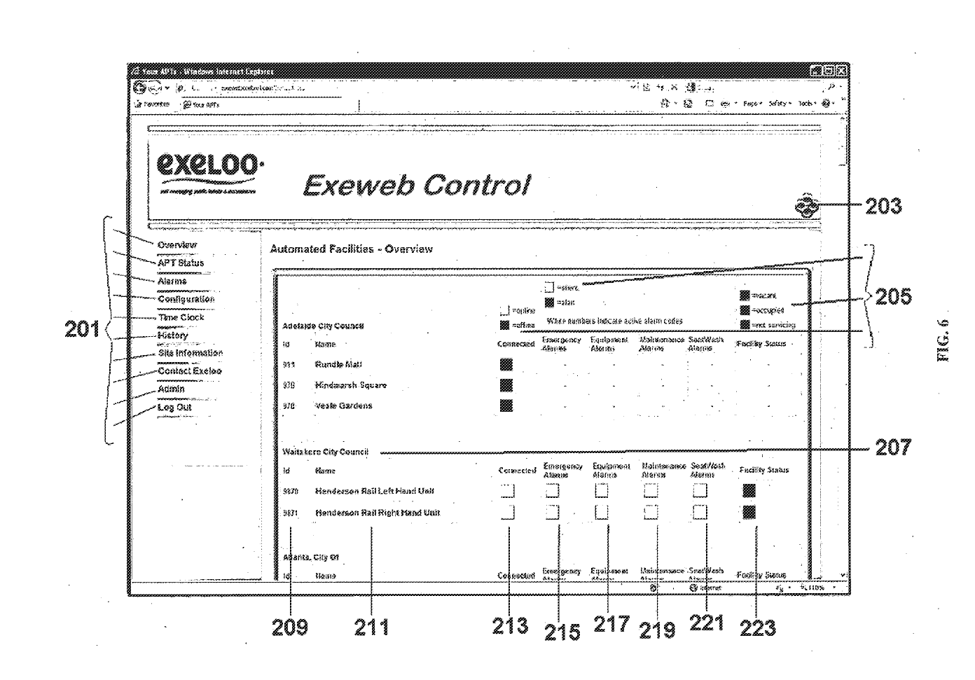

The Internet-based remote monitoring and control system of this invention is designed to be used for the remote monitoring and controlling of any PLC based automated public or private facility. In the following example, the invention is described as applied to an automated toilet facility with reference to FIGS. 6-13.

FIGS. 6-13 show screenshots of the website hosted by the server computer 109 used for monitoring and controlling of the automated toilet units. The monitoring and control system is commercially known as Exeweb control. The Internet-based monitoring and controlling website may be accessed from any PC with a Web browser by accessing the webpage www.exewebcontrol.com or www.exeloo.com.

FIG. 6 shows the overview screen of the Exeweb control website. The side menu 201 of the overview screen lists all of the options which the Exeweb control system offers. It directs users to other web pages which includes options such as ‘APT -status’, ‘alarms’, ‘configuration’, ‘time clock’, ‘history’, ‘graphs’, ‘site information’, ‘contact Exeloo’, ‘admin’ and ‘log out’. There is also an option for refreshing the web page shown by the blue symbol 203 which updates all the fields with up-to-date data from the PLCs at the connected facilities. The colour key fields 205 show the meaning of the colour indicators which are used to indicate the status of the various PLCs in the facilities monitored. In this example the colours indicate options such as green for vacant or online, red for not servicing, offline or alert, white for silent and blue for occupied.

A title 207 is assigned to each group of facilities owned by a certain individual, an organisation or a city council. Further more each facility under each title is assigned a unique ID number/job number 209 that enables the facility to be identified. Each facility is also assigned a title 211. Colour indicators 213 indicate whether a particular facility is connected to the monitoring and control system. Colour indicators 215 show whether any of the emergency alarms are activated at the particular facility monitored. Colour indicators 217 show whether any of the equipment alarms are activated at the particular facility monitored. Colour indicators 219 show whether any of the maintenance alarms are activated at the particular facility monitored. Colour indicators 221 show whether any of the seat-wash alarms are activated at the particular facility monitored. Colour indicators 223 indicate whether a particular facility is vacant, occupied or not servicing. Similarly any number of colour coded indicators could be added to the website to indicate the status of more monitored PLCs connected at a particular facility.

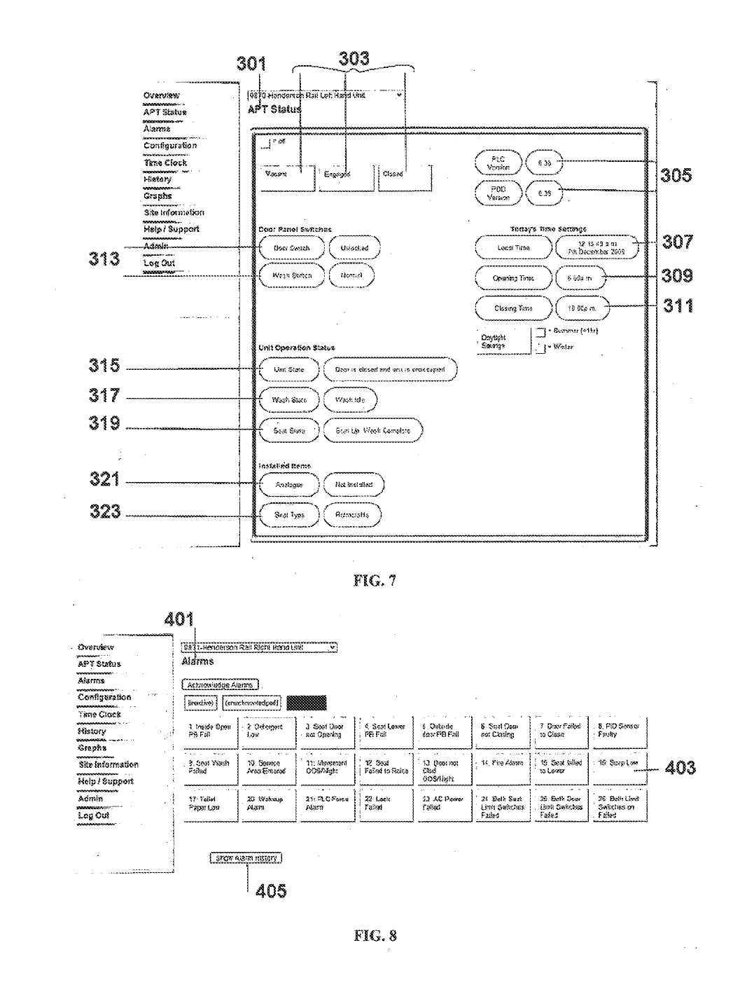

FIG. 7 shows the webpage for the option ‘APT Status’ in the side menu of the Exeweb control website. The ‘APT status’ screen 301 shows detailed status information for each individual facility. Indicators 303 show if the particular facility monitored is vacant, occupied or closed. Indicators 305 show the PLC and POD firmware versions. Indicator 307 shows the local time at the location of the facility. Indicator 309 shows the opening time of the facility monitored. Indicator 311 shows the closing time of that facility. These may be adjusted from the screen ‘time clock’ described later. Indicators 313 show the door panel switches of the facility indicating the status of the door and the wash switch. Indicators 315, 317 and 319 show the status of the facility, wash cycle state and seat wash operation state. Indicators 321, 323 indicate the various items installed at the facility. The facility could include many other indicators corresponding PLCs installed at a monitored facility.

FIG. 8 shows the webpage for the option ‘Alarms’ in the side menu of the Exeweb control website. The ‘Alarms’ screen 401 shows alarm information of the various alarms at each individual facility. The indicators 403 each show warning signs when an alarm is activated if a certain preset limit is exceeded or if a certain PLC fails to meet a preset condition at the facility. The alarm is shown by a colour change such as for example yellow or red and/or a sound. The button 405 shows the history of the alarms associated with each of the indicators shown.

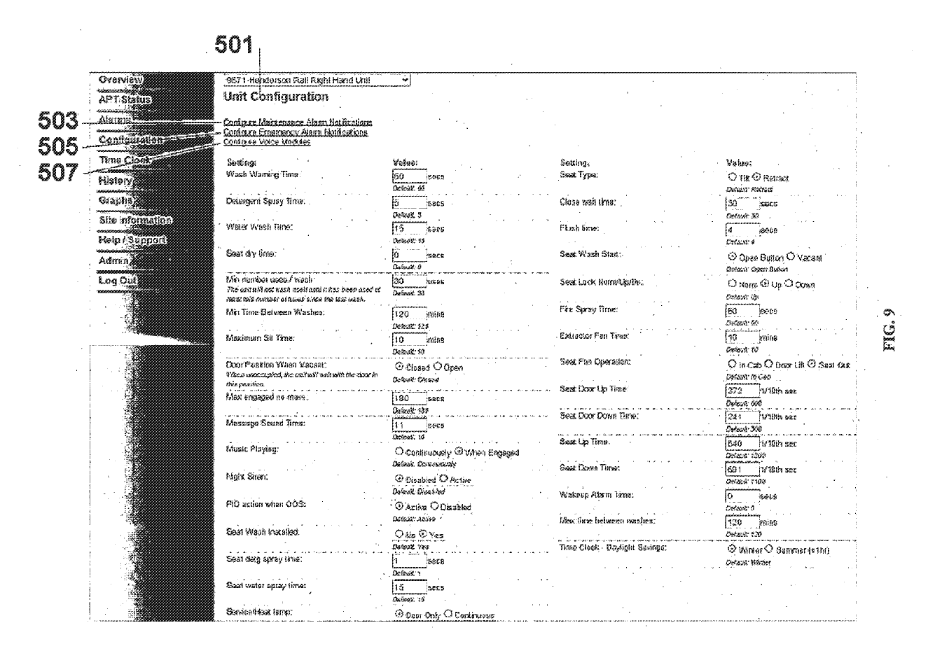

FIG. 9 shows the webpage for the option ‘Configuration’ in the side menu of the Exeweb control website. The ‘Configuration’ screen 501 displays unit configuration information for each individual facility. Each unit could be configured and controlled in terms of, for example, wash warning time, detergent spray time, water wash time and seat dry time as shown in the screenshot. The configuration page of the Exeweb control system website allows direct changes of PLC settings in real-time located at any facility which allows the system to control a facility as well as monitor it. It further has links 503, 505 and 507 that leads to several other configuration screens such as the configuration of the maintenance alarm notifications, the configuration of the emergency alarm notifications and the configuration of the voice modules.

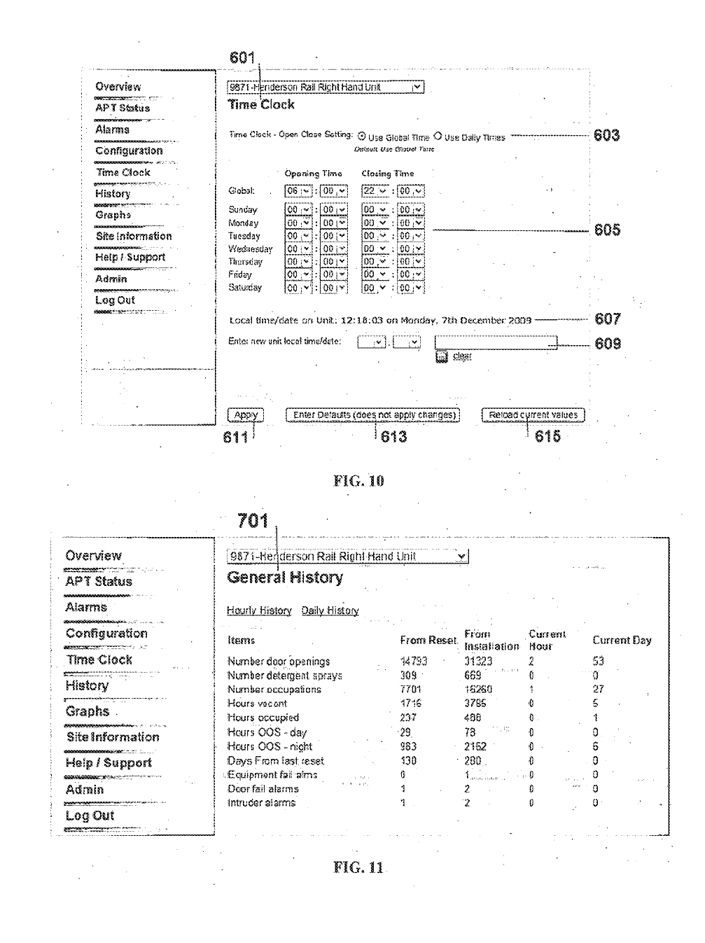

FIG. 10 shows the webpage for the option ‘Time-clock’ in the side menu of the Exeweb control website, The ‘Time-clock’ screen 601 allows the opening, closing and local time settings to be adjusted for each individual facility. Setting 603 allows the user to change from a common time setting for everyday use and a time setting for use each day of the week. Setting 605 allows the user to change the opening time and the closing time of the facility for each day of the week as required. Setting 607 shows current local time at the facility and setting 609 allows that time setting to be adjusted. Buttons 611, 613 and 615 allows the changes made to the ‘time clock’ page to be saved or default/current values to be loaded instead.

FIG. 11 shows the webpage for the option ‘General history’ in the side menu of the Exeweb control website. The ‘General history’ screen 701 displays past actions performed by the facility including number of times the door was opened, number of times the detergent was used, number of occupations as shown in the screen. This information is useful for a user for preparing future maintenance schedules, upgrading facilities or expanding toilet coverage.

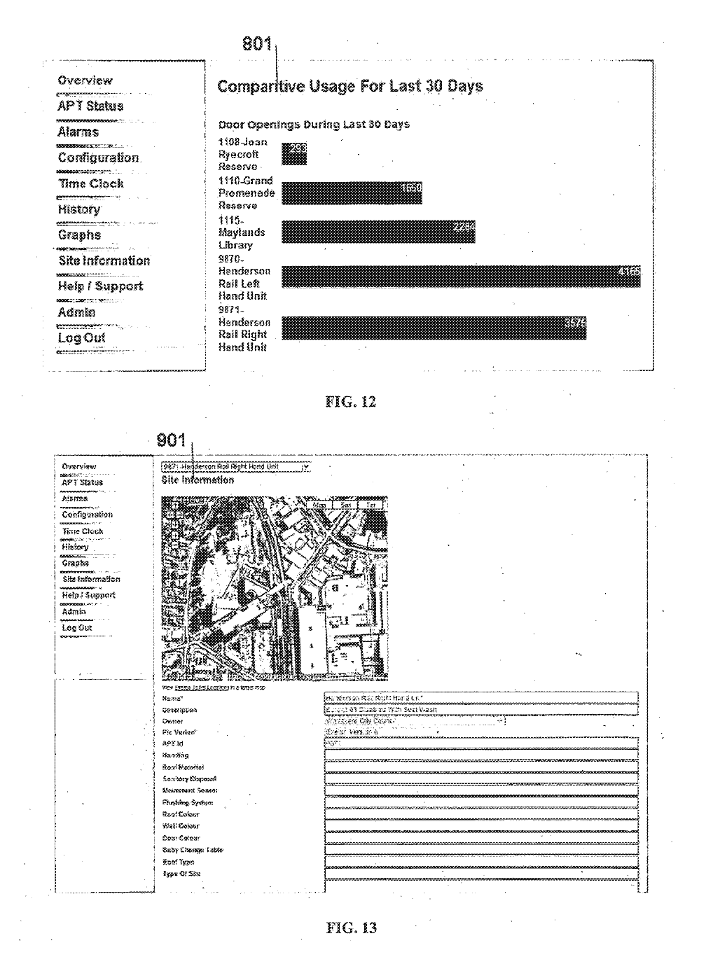

FIG. 12 shows the webpage for the option ‘graphs’ in the side menu of the Exeweb control website. The ‘graphs’ screen 801 displays various different information in graphical form from the data gathered from the PLCs at one or more facilities. The particular screen shows a comparative usage graph during the past 30 days for the number of door openings at different facilities monitored and controlled by the system. Similarly a graph could be obtained for a variety of other data gathered by the system.

FIG. 13 shows the webpage for the option ‘site information’ in the side menu of the Exeweb control website. The ‘site information’ screen 901 displays location information and a map of the facility. The webpage also displays facility related information such as owner name, facility type and model, PLC version, and facility construction details.

A user is able to use the Exeweb control system through any PC with a web browser as mentioned before. A user is required to enter a username and a password before he/she has access to the system. A username and a password is provided upon subscription to the Exeweb control system from a customer interested in having his/her toilet facilities monitored and controlled by the Exeweb control system. The subscription provider may charge a fee for providing monitoring and controlling services through the Exeweb control system for the customers' facilities, in order to generate revenue. Even though a toilet facility is mentioned in this example it could be applied to any automated facility incorporating PLCs. The automation of a facility such as a toilet could be done by the subscription provider or a private company contracted for providing automation services so that it could be monitored and controlled by the system.

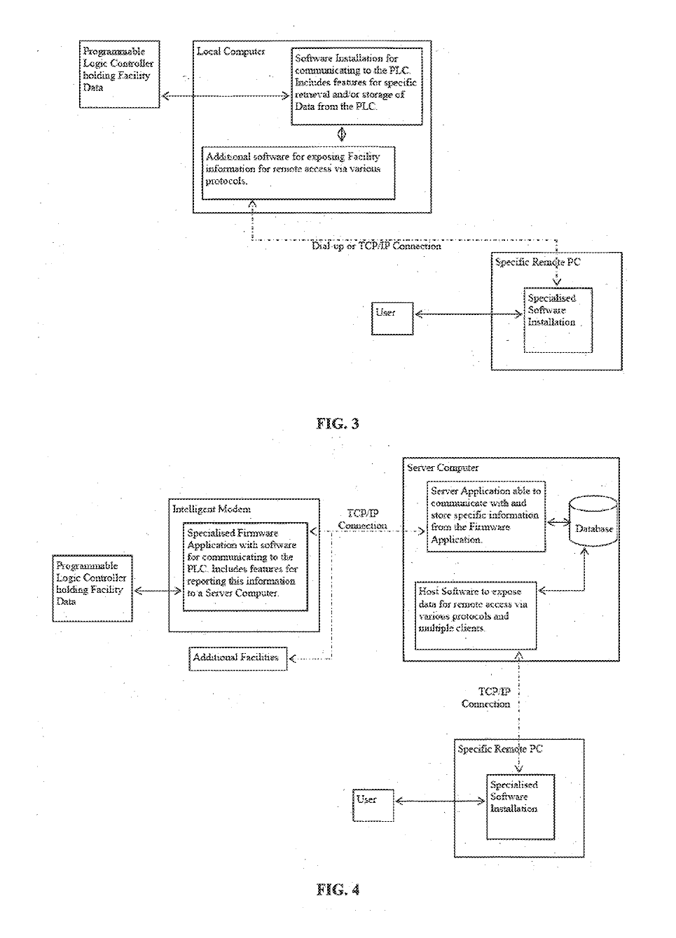

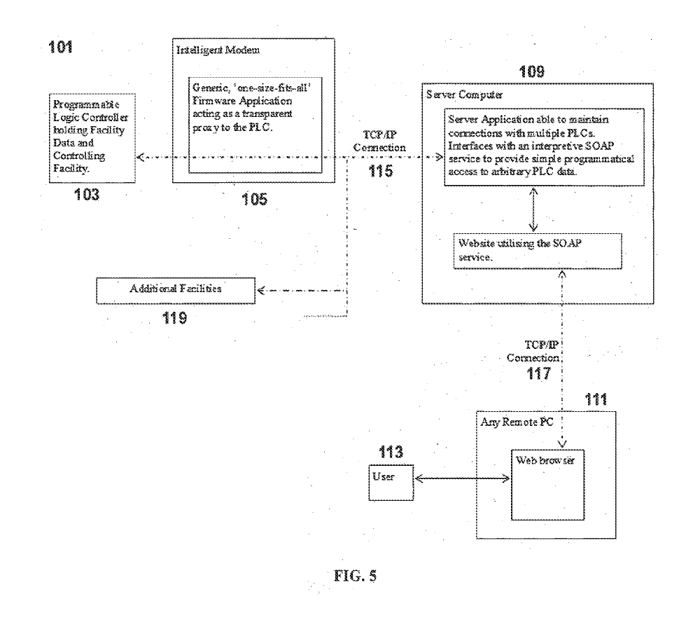

Once logged in a user is able to monitor and control automated facilities owned by them that are setup to be monitored by the Exeweb control system. A user could monitor and make adjustments to PLCs at their facilities in real-time as described above in FIGS. 2-9. The user is not required to download or install any software onto their computers as in the prior art as the system is simply accessed via a web browser.

The system has a further feature where the intelligent modem 105 of a facility is capable of sending an automated SMS message to a user so that the system could automatically notify the user when an alarm is raised or when maintenance is required at a particular facility. The user referred to here is for example a customer subscribing to the service, a distributor of the automated facilities or a cleaning/maintenance manager of the facility. The SMS message includes information for low level or high level alarms that occur on specific facilities identifying the type of alarm and the location of the toilet facility. The customers and distributors are able to acknowledge their own alarms and distributors are further able to reset ‘time clock’ settings and other functions of the system.

The customer/maintenance manager is further able to change the phone number which the modem uses to send SMS messages, by sending a coded message to the modem from his/her mobile phone. The customer/maintenance person is also able to change the settings of the modem and the PLCs by sending coded SMS messages to the modem through his/her mobile phone. Therefore with this feature the use of a PC with a web browser is not required for remotely controlling the facilities belonging to a user.

The system could be set to automatically contact every facility each night and gather data for automatic reports and the customers are also able to contact the facilities under their control directly and diagnose problems when required.

If a customer wishes to upgrade the facilities owned by them by adding more PLCs or options which require monitoring and controlling from the Exeweb control system, they can contact Exeweb control technicians in order to adapt the new options to the system.

The intelligent modems 105 of these facilities use SIM cards in order access the mobile phones of a user and the server computer 109 through the Internet. In this example, CSD type SIM cards are required for these facilities. The SIM cards are loaded with the minimum data level per month and these SIM cards are supplied either by the customers or by the distributors.

The customers would he charged a subscription fee in order to generate revenue from the Exeweb control system as mentioned before. For example, a toilet facility monitoring and controlling contract is for a 12 month period, invoiced annually or monthly. The monthly fee to a customer per facility is approximately AU $75 which is distributed as Exeloo monitoring charge to distributor at AU $15, distributor mark up at AU $15. and extra cost if SIM card is provided by distributor at AU $45.

### Advantages

The Internet-based remote monitoring and control system of this invention is accessible to users from anywhere in the world through a website hosted by a server computer. It could he viewed on any PC or hand-held unit with an Internet connection with any type of operating system. No specialised software is installed on the PCs of the users and hence updating the system only requires updating of the web-site. Updating can he done by an administrator of the system via any computer and the administrator does not need to be present at the location of the facility or at the location of remote PC of the user for an update. Downloading, redistribution or updating of software on user PCs as done in the traditional methods is not required.

The system can utilise the full capacity of an accessible server computer for the scope of data retrieval. The intelligent modem of the system does not retrieve or store any data and only acts as a transparent proxy and hence the modem does not limit the data retrieval abilities of the server. The system is advantageous over traditional processes where the scope of data retrieval is limited by the application space and/or data storage space of the intelligent modern. Furthermore the system does not require any space for or maintenance of a local computer at each facility unlike traditional methods that incorporate a local computer for increasing application capacity. No updates are required to the server application or intelligent modem firmware at any of the sites, even when the scope of the communication with PLCs increases or the manner in which data is to be displayed changes.

Improvements to the application scope of the system can be developed by any web developer in modern languages at a central location. They are relatively quick to develop. Archaic/low level code development which is required for utilising intelligent moderns of the traditional processes for PLC communication and/or presentation is not required.

With the remote monitoring and control system of this invention, no database intermediary is necessary to store data at a server and multiple automated facilities can be accessed by users simultaneously. Not having to store data on a database ensures that data is accessed in real-time with no delay between retrieving data from the PLCs and supplying it to the users. With traditional processes supporting multiple facilities via a central server, the facilities do not connect simultaneously and a database intermediary is used between the server and the remote PC software.

The monitoring and control website is controlled with user logins and passwords, providing ready opportunities for subscription-based access and revenue generation for the service provider of the monitoring and control system. Traditional processes often put use of the end-point software outside the control of the service provider, for example on the remote PC of the user, and have no method of controlling access to the software.

Summary of distinguishing features from the prior art:
The remote monitoring and control system of this invention allows the simulation of one or more direct, local connection(s) to PLC(s) at remote location(s) from a central Internet server.
It provides low-cost, real-time access to PLCs via continuous data connections between remote PLCs and a central server computer, without requiring a static IP address for each facility location.
It further provides remote monitoring and controlling capabilities via the Internet without the need to have any specific software running on the PLCs nor any facility-specific software or firmware on devices local to the PLCs.
Remote data costs are further minimized since only raw PLC data needs to be transmitted from the remote site of the PLCs i.e.: no data comprising user-interface or mid-level protocols is transmitted.
All required changes to PLC monitoring and control are implemented from a convenient, centralised location. All monitoring/control interface features can also be provided from this location.
Future developments and alterations to software can be done using high-level, efficient web programming technology implemented on the central server computer.
In addition to remote machinery control through PLCs, the website is able to feature practically unlimited dynamic content including providing support for marketing media, e-commerce, graphical reports and user-access control.
Various facilities at multiple remote locations can be monitored, controlled and compared simultaneously through a single webpage.
PLCs at multiple remote locations can be monitored and controlled in real-time via a web service interface such as SOAP, without any web services being implemented at any of the remote locations.

### Variations

The monitoring and control system of this invention is produced to be used with automated toilet facilities but it is also designed to be broad enough to handle data from any PLC controlled product or facility. Therefore the monitoring and control system can also be sold as a kit including PLCs, a modem, a power pack and sensors that can be installed in the customers' other toilet facilities so that a customer can potentially put their entire public toilet asset base onto the system. Therefore any ordinary toilet facility or other public or private facility can be automated using this kit and be monitored and controlled by the system.

The monitoring and control system can be modified to include monitoring capabilities for power meters and water meters of the automated facility. For example the system can be set up to allow remote monitoring of the water supply and the power supply to the automated toilet facility described above. The monitored data can provide accurate detail on power and water consumption on an hour by hour basis. The electronic output of the power meters and the water meters that contain usage data is connected to the PLC order to enable this function.

The system can provide the ability for customers and distributors to compare various monitored items between their automated facilities. These can include comparison of items listed in FIG. 11 between facilities. Furthermore distributors can compare items between the whole range of facility installations and create their own graphs from the data provided which maybe used to help to justify the installation of new toilet facilities.

In the preferred form of the invention described above, the interaction means is said to include an interface presentation means (a website) and an input/output means (remote PC 111). However in an alternative embodiment of the invention, the interaction means can also include an automated or semi-automated software program such as a windows service, Internet application, windows desktop application or a smart phone application which makes connections to the SOAP service as required in order to automatically control and/or monitor the automation means (PLCs) according to its pre-programmed software instructions. This removes the need to have a user interface (a website or the like) and an input/output means (a remote PC) since no input/output is required to be transferred to and from a user. Automated or semi-automated software programs designed for automatically monitoring and controlling PLCs disclosed in the prior art can be readily incorporated into the system for use in this embodiment.

Throughout the description of this specification, the word “comprise” and, variations of that word such as “comprising” and “comprises”, are not intended to exclude other additives, components, integers or steps.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

1. An Internet-based remote monitoring and control system comprising:
one or more automation means located at one or more facilities,
one or more communication means located at one or more facilities,
a service means, the service means interfacing with a protocol adaptation means,
one or more interaction means,
wherein
at least one Internet-based first connection between an automation means and the service means is established and maintained,
at least one second connection between the protocol adaptation means and an interaction means is established as required,
the first connection(s) between the automation means and the service means is being facilitated through the communication means, the communication means acting as a transparent proxy for the connection(s),
the service means makes the first connection(s) available to the protocol adaptation means to enable transfer of ‘automation means monitoring and/or controlling data’ between the automation means and the protocol adaptation means,
the protocol adaptation means enables the second connection(s) from the interaction means and enables transfer of ‘automation means monitoring and/or controlling data’ between the automation means and the interaction means,
the protocol adaptation means translates data received in the communication protocol of the automation means into the communication protocol of the interaction means and/or vice-versa.

2. A remote monitoring and control system as claimed in claim 1, wherein the first connection(s) between the automation means and the service means is established by the communications means.

3. A remote monitoring and control system as claimed in claim 1, wherein the second connection(s) between the protocol adaptation means and an interaction means is established when required by the interaction means.

4. A remote monitoring and control system as claimed in claim 1, wherein the first connection(s) between the automation means and the service means is kept alive by the service means.

5. A remote monitoring and control system as claimed in claim 1, wherein the interaction means is a combination of one or more interface presentation means and one or more input/output means.

6. A remote monitoring and control system as claimed in claim 1, wherein the interaction means is an automated or semi-automated software program such as a windows service, Internet application, windows desktop application or a smart phone application capable of automatically controlling and monitoring one or more automation means.

7. A remote monitoring and control system as claimed in claim 5, wherein the interface presentation means is a website hosted on a server computer having Internet access.

8. A remote monitoring and control system as claimed in claim 7, wherein at least one third connection between the interface presentation means and the input/output means is established when required by a user.

9. A remote monitoring and control system as claimed in claim 8, wherein the ‘automation means monitoring and/or controlling data’ is capable of being monitored and/or changed by a user by accessing the interface presentation means through the third connection(s) between the interface presentation means and the input/output means.

10. A remote monitoring and control system as claimed in claim 9, wherein the monitoring and/or changing of data through the interface presentation means results in the remote control and/or monitoring of one or more automation means located at multiple facilities in real-time.

11. A remote monitoring and control system as claimed in claim 1, wherein the automation means is a programmable logic controller (PLC) capable of automating electromechanical processes.

12. A remote monitoring and control system as claimed in claim 1, wherein the communication means is an Internet-capable intelligent cellular modem running transparent-proxy firmware capable of establishing an Internet socket connection.

13. A remote monitoring and control system as claimed in claim 12, wherein the communication means will re-establish its Internet socket connection in the event that it no longer appears to be maintained.

14. A remote monitoring and control system as claimed in claim 12, wherein the communication means is ‘one-size-fits-all’, meaning; no firmware, software or hardware customisation of the communication means is needed even where the system is applied to diverse and varying remote facilities and PLCs.

15. A remote monitoring and control system as claimed in claim 1, wherein the service means is server software hosted on a server computer having Internet access.

16. A remote monitoring and control system as claimed in claim 15, wherein the server software maintains multiple first connections between automation means located at a plurality of facilities and the server software, each first connection facilitated by a communication means located at each facility.

17. A remote monitoring and control system as claimed in claim 16, wherein the first connections are asynchronous first connections.

18. A remote monitoring and control system as claimed in claim 15, wherein the protocol adaptation means is a simple object access protocol (SOAP) service hosted on the same server computer as the service means.

19. A remote monitoring and control system as claimed in claim 18, wherein the interface between the server software and the SOAP service is a direct software interface.

20. A remote monitoring and control system as claimed in claim 11, wherein the data transferred on the first connection(s) is in PLC communication language.

21. A remote monitoring and control system as claimed in claim 18, wherein the data transferred on the second connection(s) is in secure, SOAP Web Service language.

22. A remote monitoring and control system as claimed in claim 18, wherein SOAP Web requests accepted by the SOAP service are formed by website developers with common knowledge using a developer-friendly programming object.

23. A remote monitoring and control system as claimed in claim 5, wherein the input/output means is a remote PC having Internet access.

24. A remote monitoring and control system as claimed in claim 23, wherein Internet access on the remote PC is utilised via a web browser capable of accessing a website, which makes requests to the protocol adaptation means.

25. A remote monitoring and control system as claimed in claim 1, wherein the connection between the communication means and the service means is a TCP/IP connection.

26. A remote monitoring and control system as claimed in claim 1, wherein the connection between the protocol adaptation means and the interaction means is a TCP/IP connection.

27. A remote monitoring and control system as claimed in claim 8, wherein the connection between the interface presentation means and the input/output means is a TCP/IP connection.

28. A remote monitoring and control system as claimed in claim 7, wherein access to the website is controlled by login and password details issued to users.

29. A remote monitoring and control system as claimed in claim 12, wherein the intelligent modem can send out notifications to users regarding low priority or high priority alarms or other maintenance information at the facilities.

30. A remote monitoring and control system as claimed in claim 29, wherein the notifications are sent in the form of alarm SMS messages to mobile phones of users.

31. A remote monitoring and control system as claimed in claim 30, wherein the SMS messages contain information that identifies the type of alarm and the location of the facility.

32. A remote monitoring and control system as claimed in claim 12, wherein administrative users can change the modem settings by sending SMS messages with appropriate codes to the modem.

33. A remote monitoring and control system as claimed in claim 30, wherein administrative users can change the phone numbers to which the modem will send the alarm SMS messages, by sending SMS messages with appropriate codes to the modem.

34. A remote monitoring and control system as claimed in claim 1, wherein the system can automatically contact all of the facilities at the desired intervals to gather automation means monitoring data and generate automatic reports.

35. A remote monitoring and control system as claimed in claim 9, wherein users can contact the facilities in real-time and diagnose problems at the facilities.

36. A remote monitoring and control system as claimed in claim 1, wherein the system can monitor and control any automated facility.

37. A remote monitoring and control system as claimed in claim 1, wherein the system can monitor and control any automated toilet facility.

38. A remote monitoring and control system as claimed in claim 1, wherein the system can monitor and control a non-automated facility after automating the facility with a kit containing a power pack, PLCs, a modem and sensors.

39. A remote monitoring and control system as claimed in claim 1, wherein the remote monitoring and control system allows the simulation of one or more direct, local connection(s) to PLC(s) at remote location(s) from a central Internet server.

40. A remote monitoring and control system as claimed in claim 1, wherein the remote monitoring and control system provides low-cost, real-time access to PLCs via a continuous data connection between remote PLCs and a central server computer, without requiring a static IP address for each facility location.

41. A remote monitoring and control system as claimed in claim 1, wherein the remote monitoring and control system provides remote monitoring and controlling capabilities via the Internet without the need to have any specific software running on the PLCs nor any site-specific software or firmware on devices local to the PLCs.

42. A remote monitoring and control system as claimed in claim 1, wherein the remote monitoring and control system allows remote data costs to be minimized by transmitting only raw PLC data from the remote site of the PLCs with no data comprising user-interface or mid-level protocols being transmitted.

43. A remote monitoring and control system as claimed in claim 1, wherein the remote monitoring and control system allows all required changes to PLC data to be implemented from a convenient, centralised location and all monitoring/control interface features are also provided from this location.

44. A remote monitoring and control system as claimed in claim 1, wherein the remote monitoring and control system allows future developments and alterations to software to be done using high-level, efficient web-programming technology implemented on the remote server computer.

45. A remote monitoring and control system as claimed in claim 1, wherein the website is able to provide additional support for marketing media, e-commerce, graphical reports and user-access control.

46. A remote monitoring and control system as claimed in claim 1, wherein the remote monitoring and control system allows various facilities at multiple remote locations to be monitored, controlled and compared simultaneously through a single webpage.

47. A remote monitoring and control system as claimed in claim 1, wherein the remote monitoring and control system allows PLCs at multiple remote locations to be monitored and controlled in real-time via a web service interface such as SOAP, without any web services being implemented at any of the remote locations.

48. A method of Internet-based remote monitoring and controlling an automated facility using the system claimed in claim 1, wherein the method comprises the steps of:
establishing and maintaining at least one Internet-based first connection between one or more automation means located at at-least one facility and the service means, the first connection(s) being facilitated by the communication means located at the facility and the communication means acting as a transparent proxy for the connection(s),
the protocol adaptation means interfaced with the service means being made available for a second connection from at least one interaction means,
establishing at least one second connection between the protocol adaptation means and the interaction means as required to transmit ‘automation means monitoring and/or control’ data,
the protocol adaptation means passing and/or translating requests and responses between the service means and the interaction means,
the service means transmitting the requests and responses across the appropriate applicable first connection(s) to the applicable automation means resulting in the monitoring and/or control of the applicable automation means.

49. A method as claimed in claim 48 wherein the interaction means is a combination of an interface presentation means and an input/output means.

50. A method as claimed in claim 48, wherein the method comprises a further step of a user establishing at least one third connection when required, between the interface presentation means and an input/output means, the user interacting with the interface presentation means through the third connection(s) with the input/output means and monitoring and changing data made available through the requests and responses.
